(19) United States
(12) Patent Application Publication
(10) Pub. No.: US 2015/0156717 A1
(43) Pub. Date: Jun. 4, 2015

(54) APPARATUS AND METHOD FOR WIRELESS MOBILE DEVICE POWER SAVINGS

(71) Applicant: MOTOROLA MOBILITY LLC, Chicago, IL (US)

(72) Inventors: Murali Narasimha, Vernon Hills, IL (US); Robert T. Love, Barrington, IL (US); Apostolis K. Salkintzis, Athens (GR)

(73) Assignee: MOTOROLA MOBILITY LLC, Chicago, IL (US)

(21) Appl. No.: 14/257,189

(22) Filed: Apr. 21, 2014

Related U.S. Application Data
(60) Provisional application No. 61/910,979, filed on Dec. 3, 2013.

(51) Int. Cl. H04W 52/02

(52) U.S. Cl. CPC H04W 52/0209

(57) ABSTRACT

A method and apparatus provide power savings in a wireless mobile device. The wireless mobile device is capable of communicating within a first wireless communication system using a first wireless modem and communicating within a second wireless communication system using a second wireless modem. The wireless mobile device associates with the second wireless communication system, determines that the second wireless communication system includes a paging offload function, establishes a link to the paging offload function, provides a set of parameters over the link that the paging offload function can use to monitor signals of the first wireless communication system on behalf of the wireless mobile device; and changes a mode of the first modem of the wireless mobile device into a power saving mode.

### FIELD OF THE INVENTION

The present invention relates generally to wireless mobile communication systems and wireless mobile communication devices, and more specifically to apparatus and methods used in wireless mobile devices for battery saving.

### BACKGROUND

Since the advent of mobile wireless communication systems many decades ago, there has been a strong emphasis on reducing the power consumption in the wireless mobile devices used in the communication systems by making engineering improvements to the wireless mobile communication devices (e.g., military walkie talkies, pagers, handheld radios, and cell phones) and to the protocols used in the wireless communication systems within which they work. Making these improvements is paramount to making the wireless mobile communication devices smaller and able to operate for longer times between battery recharges, both of which are highly desirable user features.

Here are but a few of many examples of such improvements: new battery technologies; the introduction of paging channels and the synchronization of the wireless mobile device to the wireless communication system so that the wireless mobile device need come on only during times when it is to attempt reception of a page; more base stations to lower the required transmit power of the wireless mobile devices; sophisticated control of the transmission power of the wireless mobile devices, and lower operating voltages for active circuits. The impetus to reduce power drain in wireless mobile devices remains.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments. The description is meant to be taken in conjunction with the accompanying drawings in which:

FIG. 1 is a system diagram that shows portions of two wireless communication systems, in accordance with certain embodiments.

FIG. 2 is a flow chart that shows some steps of a method used in a wireless mobile device operating in a first one of the wireless communication systems described with reference to FIG. 1, in accordance with certain embodiments.

FIGS. 3-7 are flow charts that show more steps used in the method described with reference to FIG. 2, in accordance with certain embodiments

FIG. 8 is a flow chart that shows some steps of a method used in a paging offload function that operates with a node in a second one of wireless communication systems described with reference to FIG. 1.

FIG. 9 is a functional block diagram that shows the wireless mobile described with reference to FIG. 2, in accordance with certain embodiments.

FIG. 10 is a functional block diagram that shows a wireless network device that includes the paging offload function described with reference to FIG. 8, in accordance with certain embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments . . . .

### DETAILED DESCRIPTION

Before describing in detail the following embodiments, it should be observed that the embodiments reside primarily in combinations of method steps and apparatus components related to wireless mobile communication devices (hereafter, wireless mobile devices) and wireless network communication devices (hereafter, wireless network devices). The wireless mobile device may, for example, be a mobile cellular device operating in a first wireless communication system that is a cellular communication system. The wireless network device may, for example, be a modified Wi-Fi node operating in a second wireless communication system (a Wi-Fi network). The wireless network device has the ability to monitor the transmissions of the first communication system to receive messages intended for the wireless mobile. The wireless mobile device associates with the wireless network device using a wireless modem that is compatible with the second wireless communication system. The wireless mobile device can then shut down a modem that it has for communicating with the first wireless communication system until a message is received by the wireless network device that includes information specifically for the wireless mobile device. This can result in substantial power savings for the wireless mobile device while the modem in the wireless mobile device is shut down.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

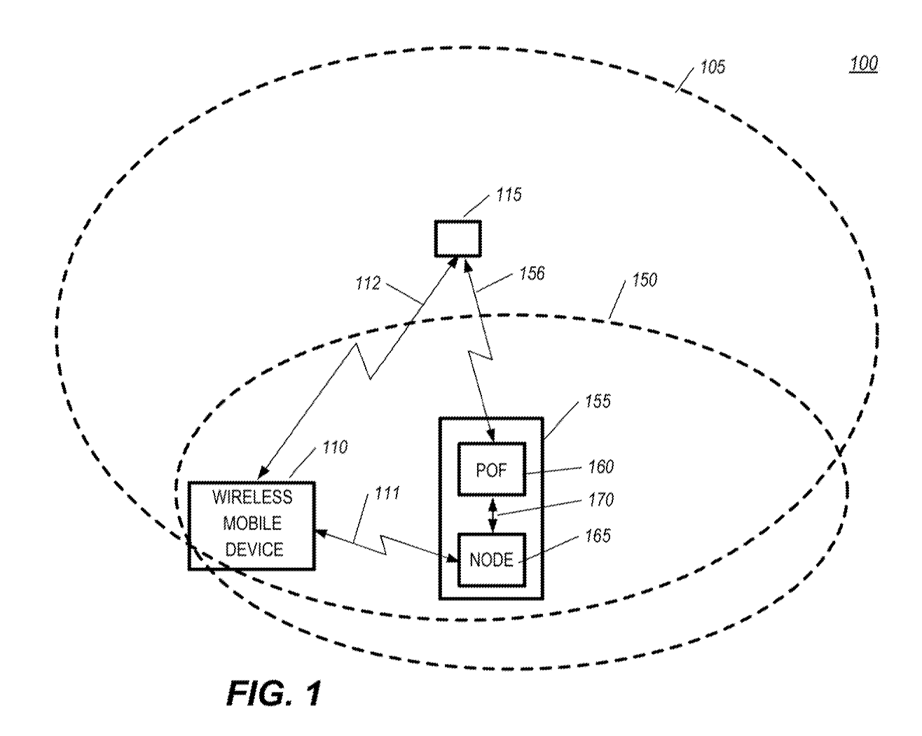

Referring to FIG. 1, a system diagram 100 of portions of two wireless communication systems is shown, in accordance with certain embodiments. A coverage area 105 of a first wireless communication system is shown with dotted lines in FIG. 1. A coverage area 150 of a second wireless communication system is also shown with dotted lines in FIG. 1. This type of illustration of wireless coverage area of a wireless communication system is often used, but is recognized as being idealistic. The coverage areas 105, 150 may each represent a part of an overall coverage area of the entire respective coverage of each of the first and second wireless communication systems, or may represent the whole coverage of one or the other, or both, of the first and second wireless communication systems. For example, in some embodiments either wireless communication system may be a wide or medium area coverage system, such as a cellular system, a WiMAX® (WorldWide Interoperability for Microwave Access) system (specified by the IEEE 802.16x family of standards), or an iDEN® (Integrated Digital Enhanced Network system, distributed by Motorola Solutions, Inc. In other embodiments either wireless communication system may be a local area system, such as a Wi-Fi® system (specified by IEEE 802.11x specifications) or a cellular microcell or a Bluetooth® system (specified by the Bluetooth Special Interest Group). A wireless network device 115 is a network device for the first wireless communication system; a wireless network device 155 is a network device for the second wireless communication system, and wireless mobile devices such as wireless mobile device 110 operate in the first wireless communication system. Wireless mobile devices may also operate in the second wireless network, but none are shown in FIG. 1. The wireless network devices 115, 115 each provide wireless transmissions according to the protocol of the associated wireless communication system. There may be a plurality of wireless network devices 115 in the first wireless communication system and there may be a plurality of wireless network devices 155 in the second wireless communication system.

Each of the coverage areas 105, 150 may represent a portion of coverage provided by a single network device in each wireless communication system. For example, each coverage area 105, 150 may be provided by energy being transmitted and received from a single antenna coupled to each one of the wireless network devices 115, 155. For example, either or both antennas may be a sector antenna positioned on a cellular communication system antenna tower or, for example, an antenna coupled to wireless network device 155 may be an omnidirectional antenna for a Bluetooth, Wi-Fi, or IDEN network. As depicted in FIG. 1, the (ideal) coverage areas of the first and second wireless communication systems overlap. However, the protocols of the first and second wireless communication systems are non-conflicting; that is, a wireless mobile device, such as wireless mobile device 110, that is capable of communicating within both wireless communication systems wirelessly can simultaneously communicate with both the first and second wireless communication systems, when the wireless mobile device 110 is in a location such that it has sufficient two way wireless signal strength with both systems. Each of the wireless mobile devices 110 has two wireless modems (which may also be referred to as modems or wireless transceivers); a first modem and a second modem. The two modems are used to provide simultaneous wireless communications, respectively, with the first and second wireless communication systems. The wireless mobile device may be any mobile device having the characteristics mentioned and having specific functions described herein, some of which are uniquely added to obtain the benefits described herein. An example of a wireless mobile device that has the functions described herein is a mobile cellular telephone (smart phone) having “hot spot” capability that has the unique functions as described herein. Other existing cellular devices, such as pads and readers that don't have a second modem could be modified with the addition of a second modem and unique functions described herein.

In an embodiment in which the wireless mobile device 110 is a cellular mobile device in a cellular system, the first modem of the mobile cellular device is a modem for the first wireless communication system, which is a cellular communication system. The second modem of the wireless mobile device 110 is a modem that is compatible with the second wireless communication system. The wireless network device is a cellular base station. The cellular system may be, for example, one using LTE (Long Term Evolution), UTRAN (Universal Terrestrial Radio Access Network), WCDMA (WideBand Code Division Multiple Access), CDMA 2000 1xRTT, and CDMA2000 1x EV-DO technologies, or other cellular technologies. These technologies and other cellular system technologies are defined in standards issued by one of two independent standards issuing bodies: 3GPP and 3GPP2. These standards and other can be accessed, respectively, at www.3gpp.org and 3Gpp2.org.

The wireless network device 155 comprises a paging offload function 160 and a network node 165. The paging offload function (POF) 160 comprises a first wireless modem (first modem) and is capable of at least receiving communications transmitted by the first wireless communication system, as well as performing other unique functions described herein below. The POF 160 is communicatively coupled to the node 165. The node 165 comprises a second wireless modem (second modem) and is capable of communicating wirelessly with the second modem of the wireless mobile device 110, typically using conventional methods defined for the second wireless communication system. The node 165 and the POF 160 may be separately packaged devices or may be included within one packaged device. When they are separately packaged, they may communicate over a link 170 that is wired, such as with an Ethernet cable or other type of cable, or with a wireless connection 170. When they are separate packages and communicate wirelessly, they may communicate using a wireless protocol of the second communication system, or using another wireless protocol that does not interfere with the first or second wireless communication system. For example, the first wireless communication system may be a cellular system, the second wireless communication system may be a Wi-Fi system, and the method that is used for communicating between the paging offload function 160 and the network node 165 may be one of Wi-Fi or Bluetooth. When they are packaged as one unit, the POF 160 may communicate with the node 165 using electronic circuit techniques, of which one example is passing communications between software functions within a processor. Another example is passing communications between a first processor that processes functions of the node 165 and a second processor processing the paging offload function 160, using a data bus. When the POF 160 and the node 165 are separate packages, the node 165 may be a conventional node, such as a conventional Wi-Fi node.

An aspect of the physical locations and operational characteristics of the wireless mobile device 110 and the node 165 is that when the wireless mobile device 110 is operating within the first wireless communication system and is within operational range of the wireless node 165, power savings may be achieved in the wireless mobile device 110 by effectively transferring monitoring of the first communication system by the wireless mobile device over to the POF 160. The power savings is achieved by shutting down the first modem of the wireless mobile device until the POF 160 detects a message on the first wireless communication system that is for the wireless mobile device 110 and transmits the information in the message back to the wireless mobile device 110 through the second modem that is within the node 165. This will occur if and when the combined power drain of the first and second modems of the wireless mobile device 110 before going into the monitoring mode is greater than the power drain of the second modem of the wireless mobile device 110 after going into a power saving mode (i.e., a shut-off mode or a greatly reduced power mode) of the first modem of the wireless mobile device 110.

In an example in which the wireless mobile device 110 is a cellular mobile device, and the second wireless communication system is a Wi-Fi or Bluetooth system, it will be appreciated that circumstances may arise when the cellular mobile device 110 is operating at a location that has low but marginally usable signal strength in the cellular communication system but has sufficient signal strength to communicate well with the second communication system. The cellular mobile device 110 may also be operating in a mode in which it can power down the cellular modem completely or for very long duty cycles without substantially diminishing effective operation of the cellular mobile device. This situation can arise when the cellular mobile device is not engaged in voice communication or communication of data messages. The fact that the mobile cellular device is in a low signal strength region can cause the power drain of the cellular modem to greatly increase as it attempts to maintain operational status. For example, the cellular modem of the wireless mobile device may switch to a 2G cell due to the low cellular signal strength but may be frequently switching between the 2G cell and a 3G cell to determine whether the communications via the 3G cell are better under the circumstances (also called 3G-2G hunting herein). Alternatively, the cellular communication system signal strength may be low enough that the cellular modem is being switched off and on frequently to determine whether a sufficiently good signal now exists (also called signal hunting herein). Such situations are common indoors and in lower floors of buildings which are located where the outdoor signal strength of the cellular system is quite acceptable. While the outdoor signal strength of the cellular system in such areas may be acceptable, the signal strength can often be marginal or unacceptably low indoors. In these situations, there may exist a second wireless communication system that can be provided with a paging offload function 160 that, in conjunction with functions of the mobile cellular device provide power savings in the mobile cellular device.

In these circumstance, the first modem of the wireless network device 155 may be able to have good communications with the first wireless communication system. Furthermore, a second modem of the second communication system may be able to have good communication with the wireless mobile device at a very low power drain. For example, when the second communication system is a Wi-Fi system, the second modem of the wireless mobile device 110 may be communicating with the Wi-Fi system via a conventional node of the Wi-Fi system that is near the wireless mobile device 110. The conventional node of the Wi-Fi system and the wireless mobile device 110 may both be located in a low signal strength area of the first wireless communication system, such as a lower floor of a multistory urban building, or a basement of a private residence. The POF 160 may be located in the top floor or a higher floor of the building, providing the good communications that are needed with the first wireless communication system. The POF 160 can couple information that is received for the wireless mobile device 110 to the node 165, which can communicate the information via the conventional node of the second wireless communication system to the nearby wireless mobile device 110.

In some situations, the wireless mobile device 110, the POF 160 and the node 165 may all be in a location where the wireless mobile device 110 does not have good communications with the first wireless communication system, but the POF 160 has good communications with the first wireless communication system. For example, the POF 160 may be able to use an antenna for the first modem of the POF 160 that is in a better location and/or has a much higher gain than the antenna for the first modem of the wireless mobile device 110. Also, because there may not be significant power limitations for the POF 160, because the POF 160 may operate from a power main, such as 120 Volts AC. This may allow improved performance of the receiver of the POF compared to the receiver of the first modem of wireless mobile device.

In embodiments in which the first communication system is a cellular communication system and the second communication system is a Wi-Fi system, the cellular modem of the mobile cellular device may be drawing an average of 10 or more milliamps from a battery of the cellular device due to a poor signal environment when the mobile cellular device is not communicating data or voice information. Maintaining a connection to the Wi-Fi node may only require one milliamp of average battery drain in the mobile cellular device. Putting the cellular modem into a power saving mode (in which monitoring for messages from the cellular communication system is interrupted) and allowing the POF to monitor the cellular communication system for messages that have information for the mobile cellular device can save substantial power during the power saving state of the mobile cellular device.

This principle applies to other combinations of communication system types for which situations arise in which 1) the power drain of the first modem of the wireless mobile device while monitoring the first wireless communication system is, or becomes, greater than the power drain required for the wireless mobile device to communicate to a wireless network device using the second modem of the wireless mobile device, 2) the power drain of the wireless network device is not a significant issue, 3) the wireless network device can monitor the first wireless communication system for messages for the wireless mobile device and communicate the information in the messages to the wireless mobile device, and 4) the first modem of the wireless mobile device can be put into a power saving mode which drains substantially less power than the power drain during which the wireless mobile device is monitoring the first wireless communication system for messages. For example, the principle may apply to wireless mobile devices operating in a Wi-MAX system that come within range of a Wi-Fi or microcell of a cellular system.

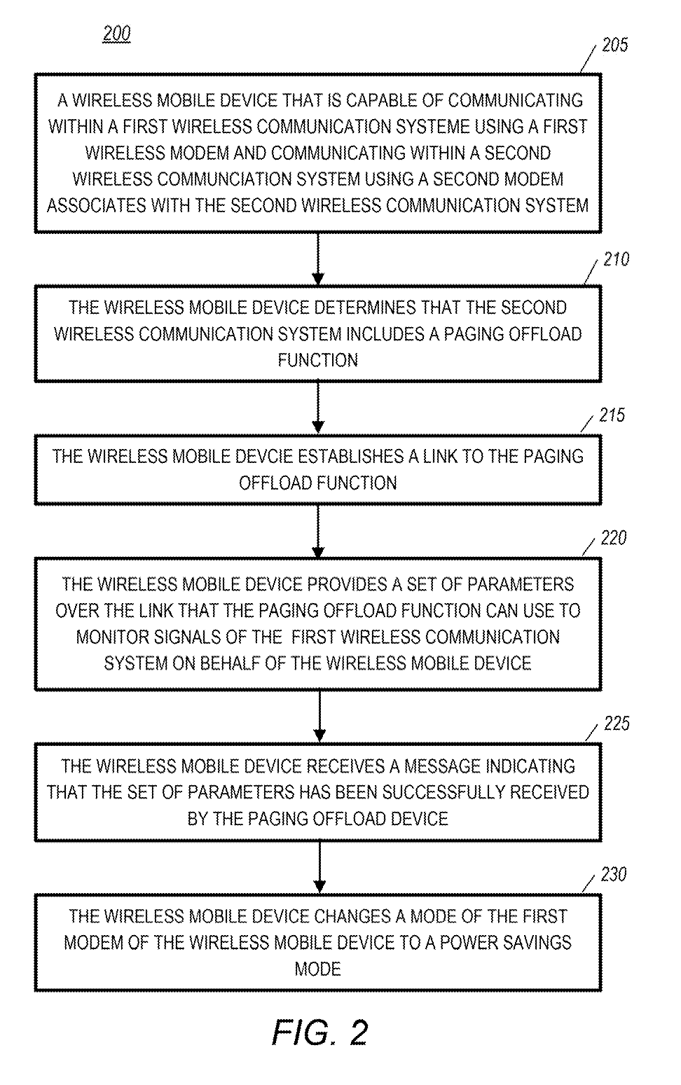

Referring to FIG. 2, a flow chart shows some steps of a method 200 used in a wireless mobile device, in accordance with certain embodiments. The wireless mobile device may be one such as wireless mobile device 110 (FIG. 1), and is capable of communicating with a first wireless communication system using a first wireless modem and communicating with a second communication system using a second modem. At step 205 (FIG. 2), the wireless mobile device associates with the second wireless communication system. In this context, “associating with” means that the wireless mobile device, upon being brought into proximity to the second wireless network, has discovered the existence of the second wireless communication system, and has been accepted for communicating information with the second wireless communication system. “Discovering the existence of the second wireless communication system” may include synchronizing a receiver of the second modem of the wireless mobile device with signals transmitted on a particular broadcast channel by a node (such as node 165, FIG. 1) of the second wireless communication system, determining an identity of the second wireless communication system, and determining other non-secure information. Other non-secure information may include information about the security status of the wireless communication. In some embodiments, “being accepted for communicating information with the second wireless communication system” includes successful performance of security establishment protocols, followed by the use of encryption for information that is passed between the wireless mobile device and the second communication system. At step 210 (FIG. 2), the wireless mobile device determines that the second wireless communication system includes a POF, such as POF 160 (FIG. 1). In some embodiments, this information about the inclusion of a POF could be a portion of unsecured broadcast information acquired during step 205. In some embodiments, the information that the second communication system includes a POF may be obtained by a discovery protocol that is defined for use between the wireless mobile device and the POF using a link of the second wireless communication system. The wireless mobile device then establishes a link to the POF at step 215. This link may be a link directly to a wireless network device (such as wireless network device 155 (FIG. 1), when the wireless network device includes a node 165 and a POF 160 of the second wireless communication system. Alternatively, the link may be through a node 165 of a wireless network device that does not include a POF, through one or more other nodes of the second wireless communication system to one of the one or more nodes that is coupled to or incorporates a POF. At step 220, the wireless mobile device provides a set of parameters over the link that the POF can use to monitor signals of the first wireless communication system on behalf of the wireless mobile device. These parameters allow the POF to monitor the first wireless communication system for information that is directed to the wireless mobile device. In some embodiments the POF only needs to be able to receive signals from the first wireless communication system (i.e., a transmitter is not needed in these embodiments for transmitting signals to the first wireless communication system). At step 225, the wireless mobile device receives a message indicating that the set of parameters has been successfully received by the paging offload function, and in response, the wireless mobile device changes into a power saving mode of its first modem at step 230.

Either or both of the steps of sending the parameters to the POF (step 220) and going into the power saving mode (step 225) may be contingent upon one or more factors. In some embodiments, the wireless mobile device may associate with the second wireless communication system and may establish a link to the POF, but does not provide parameters for the POF to monitor the first communication system when the wireless mobile device is in certain modes, or until certain conditions arise. For example, when the wireless mobile device is in a voice call or an emergency mode it may be designed never to send parameters and go into the power saving mode. As another example, when the wireless mobile device is receiving, transmitting, or exchanging data files, it may not send the parameters to the POF and go into the power saving mode. On the other hand, when the wireless mobile device is not in a voice call and not sending, receiving, or exchanging data files, the wireless mobile device may be designed to send the parameters and go into the power saving mode when the wireless mobile device becomes associated with a second wireless communication system and has determined that it includes a POF. The wireless mobile device may also go into the power saving mode when it has associated with a second wireless communication system and has determined that it includes a POF, and ends a voice call or stops sending, receiving, or exchanging data files. Other conditions could be used. For example, sending the parameters could be contingent upon the wireless mobile device making a determination that the power drain of its first modem has risen beyond a threshold, based on actual power drain measurements (i.e., current drain) or a transmission duty cycle. These determinations are likely to be made when a wireless mobile device is a cellular device and is operating under poor signal conditions.

The parameters that are sent to the POF by the wireless mobile device are the parameters that the POF will need to monitor the first wireless communication system on behalf of the wireless mobile device. This means that the POF must be able to determine when information or messages are available and intended for the wireless mobile device, or that there is an incoming voice call for the wireless mobile device. “Intended for” in some embodiments may be that the information or message or call is only for the particular wireless mobile device (e.g., it is a point-to-point communication). In some embodiments, “intended for” may include certain or all multipoint communications. For example, family conference calls may be included in some embodiments, perhaps as a user selectable option, as being “intended for” the wireless mobile device. A broadcast emergency call or message may be included in some embodiments as being “intended for” the wireless mobile device. In some embodiments all broadcast, multicast and point to point messages may be categorized as being intended for the wireless mobile device. In some embodiments, “intended for” may include messages used to initiate user communication (such page messages). In some embodiments, “intended for” may include messages to restart communication activity after a period of inactivity (such as data ready indications and Physical downlink control channel (PDCCH) order in LTE).

In cellular systems such as LTE and UMTS, there are two modes for which the mobile cellular device may send the parameters to the POF and go into the power saving mode: one is termed the idle mode and the other is the connected mode. In the idle mode, the mobile cellular device looks for paging messages that indicate that the mobile cellular device has an incoming communication (such as an incoming voice call or a data connection), and does not transmit to the network unless such a paging message is received. To save power in idle mode, idle mode discontinuous reception (DRX) functions are performed. Idle mode DRX procedures involve activating the cellular modem (the first modem) for paging occasions of the wireless mobile device. Paging occasions are time periods during which paging messages for the wireless mobile device, if any, are transmitted. Parameters used for idle mode DRX functions include the idle mode DRX cycle period and the paging occasion. The idle mode DRX cycle period is the time period over which the cellular network transmits one page message for each device that needs to be paged. The paging occasion indicates the time period within the idle mode DRX cycle period in which the wireless mobile device can expect a page, if any. The idle mode DRX cycle period and the duration of the paging occasions depend various factors including the technology and the needs of the network operator; for example the idle mode DRX cycle period can be 640 ms or 1280 ms and the duration of the paging occasions can be 1 ms, 10 ms, or 80 ms depending on the technology.

Using idle mode DRX procedures in idle mode saves current in comparison to idle mode without idle mode DRX procedures. But the power drain can go up significantly even in the idle mode when the signal strength degrades, for the reasons described above as 3G-2G hunting or signal hunting.

In the connected mode the wireless mobile device is directed by the system to activate its cellular modem at a defined period for transmission and reception of data. When the wireless mobile device is not actively communicating data (e.g., data files or streaming data or data packets), the system may use connected mode DRX functions to place the connection in a mode that uses less frequent and shorter transmission times. Parameters for connected mode DRX include a connected mode DRX cycle period, a connected mode DRX offset and an on duration. The connected mode DRX cycle period is the period over which the network can perform one attempt to re-initiate communication with all devices that are operating in connected mode DRX mode. The connected mode DRX offset is the time offset from the start of the connected mode DRX cycle to the start of the on duration. On duration is the time period in the connected mode DRX cycle period during which the wireless mobile device can expect the network restart of communication activity. For example, the network can restart data transmission to the wireless communication device during the on duration, which the wireless communication device receives. If the network restarts data transmission for the wireless communication device in a period other than the on duration of the wireless mobile device, the wireless mobile device does not receive it because the cellular mobile device places its cellular modem in an inactive state during such periods. Thus the connected mode DRX functions enable power saving compared to connected mode operation without DRX.

An inactivity timer is employed with connected mode DRX in certain cellular systems. If there is an extended period comprising multiple connected mode DRX cycles during which no data is transmitted to or received from the wireless mobile device, the wireless mobile device has to perform resynchronization before data transmission can be restarted. In order to cause the mobile station to perform resynchronization, the network can transmit a “data ready” signal to the cellular mobile device during the on duration of the cellular mobile device. The cellular mobile device performs resynchronization procedures, after which data transmission is restarted. One example of the inactivity timer and the data ready signal is described as follows for an LTE system. An LTE cellular mobile device starts (or restarts) a timing advance (TA) timer for a specified duration when a timing advance command is received from the network. When the timing advance timer expires, the cellular mobile device disables all transmissions to the network. In such a situation, when data transmission to the cellular mobile device needs to be restarted, the network transmits a physical downlink control channel (PDCCH) order to the cellular mobile device during its on duration. Upon receiving the PDCCH order, the cellular mobile device performs a random access transmission to the network and receives a timing advance command in response. Subsequently, the data transmission is restarted. In some embodiments an inactivity timer measures a duration since the last data was transmitted or received by the wireless mobile device. In some of these embodiments, “data” refers to information being transported, not to any data used to accomplish the transport of the information. A power savings inactivity threshold may then be defined. When the inactivity timer reaches the inactivity threshold, the wireless mobile device disables all transmissions to the first wireless communication system.

Connected mode operation with connected mode DRX may not have a high power drain in strong signal areas, but can have significantly increased power drain in poor signal conditions for the reasons described above as 3G-2G hunting or signal hunting.

In accordance with some embodiments, in either of these modes a cellular mobile device, upon discovering a second wireless communication system that has a POF, will communicate parameters to the POF that define the timing needed for the POF to monitor the first wireless communication system and then go into a power saving mode. In the case of the idle mode, the mobile cellular device may link to the POF and provide the idle DRX parameters without substantial delay after discovering the second wireless communication system that has a POF. The parameters allow the POF to receive a paging message intended for the wireless mobile device. In this idle mode, the parameters include a paging identity, an idle mode DRX cycle duration, and a paging occasion. The paging identity is the identifier used by the cellular network to identify the device that is being paged. In the case of the connected mode, the mobile cellular device may first allow an inactivity timer (such as the timing advance timer) maintained by the first modem to expire prior to sending the parameters to the POF, in order to cause the communication system to send a data ready signal when information becomes available for the wireless mobile device. In this connected mode, the parameters include connected mode Identifier, connected mode DRX Cycle period, connected mode DRX offset and on duration, which allow the POF to receive a data ready indication from the second wireless communication system. The connected mode identifier is the identifier used by the network to transmit messages that are specific to the cellular mobile device. One example of the connected mode identifier is the Cell Radio Network Temporary Identifier (C-RNTI). It will be appreciated that other cellular systems (e.g. UTRAN, W-CDMA, 1xRTT, and 1xEV-DO) and other wireless communication systems have similar modes in which the power drain of the first modem can become significant, and a POF function having capabilities that are equivalent for the other wireless communication system can allow a wireless mobile device having equivalent capabilities to put a first modem of the other wireless communication system into a similar power saving mode.

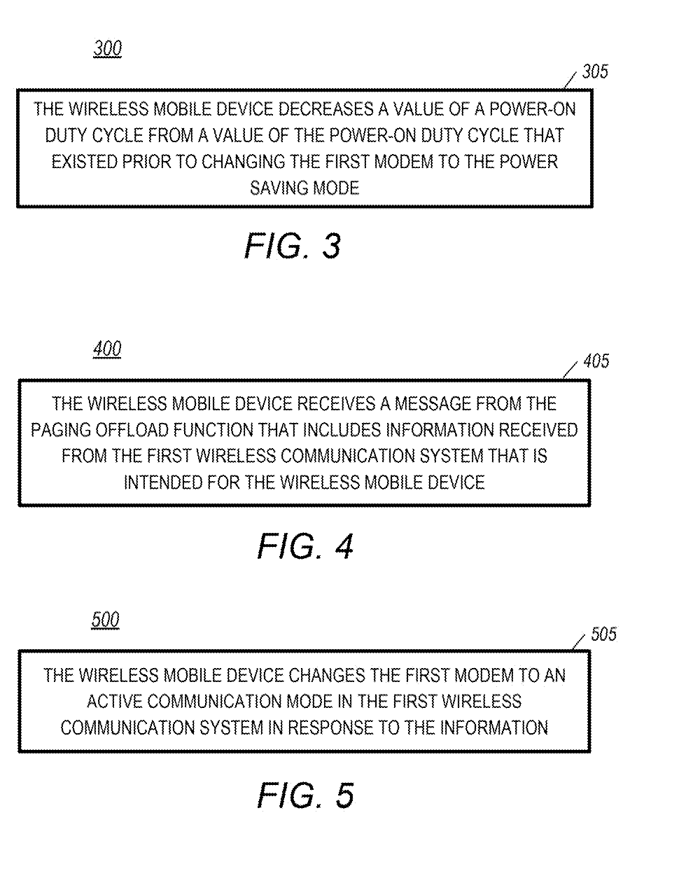

Referring to FIG. 3, a flow chart 300 shows a step used in step 230 of the method 200 described above with reference to FIG. 2, in accordance with certain embodiments. At step 305, the wireless mobile device decreases a value of a power-on duty cycle of the first modem from a value of the power-on duty cycle that existed prior to changing the first modem to the power saving mode. In some embodiments, the power-on duty cycle may be changed to zero. This is equivalent to the first modem being “off.” Being “off” may be a mode in which the first modem has extremely low power drain, i.e., just enough to sense a signal that changes it back to an “on” mode. In some embodiments, the power-on duty cycle is reduced to a minimum that allows the first modem to remained in synchronization with the first communication system timing, involving a very low receive only duty cycle. In some of these embodiments, the power on duty cycle may be reduced by more than 5 times compared to the power on duty cycle that existed prior to changing the first modem to the power saving mode. As noted above, this power saving mode may reduce the average current drain for a contemporary first modem of a wireless mobile device to less than a milliamp

Referring to FIG. 4, a flow chart 400 shows an additional step of the method 200 described above with reference to FIG. 2, in accordance with certain embodiments. At step 405, the wireless mobile device receives a message from the paging offload function that includes information received from the first wireless communication system that is intended for the wireless mobile device. The meaning of “intended for” has been described above.

Referring to FIG. 5 a flow chart 500 shows a step used after the step 405 described above with reference to FIG. 4, in accordance with certain embodiments. At step 505, the wireless mobile device changes the first modem to an active communication mode in the first wireless communication system. In LTE cellular systems, the active communication modes may be a Radio Resource Controlled mode and a connected mode. In other cellular communication systems and other types of wireless communication systems, there may be equivalents to one for both of the modes described for the LTE cellular systems.

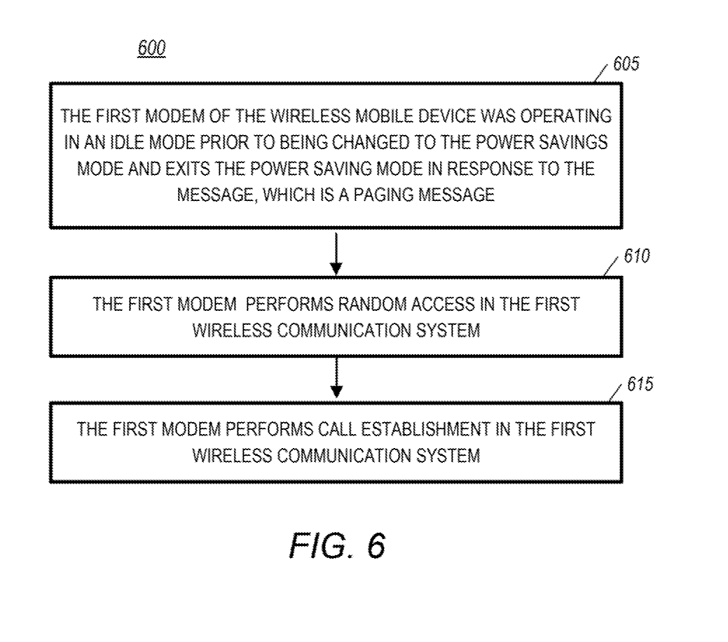

Referring to FIG. 6, a flow chart 600 shows some steps used after step 405 described above with reference to FIG. 4, in accordance with certain embodiments. In these steps 605-615, the first modem of the wireless mobile device was operating in an idle mode of the first wireless communication system prior to being changed to the power saving mode. In this step, idle mode refers to idle mode using DRX procedures, or other modes for which paging is used. In this example the first wireless communication system is an LTE cellular system. However these steps are applicable to other wireless communication systems that have equivalent functions. At step 605, the first modem exits the power saving mode in response to the message, which is a paging message. At step 610, the first modem performs random access in the first wireless communication system. At step 615, the first modem performs call establishment in the first wireless communication system.

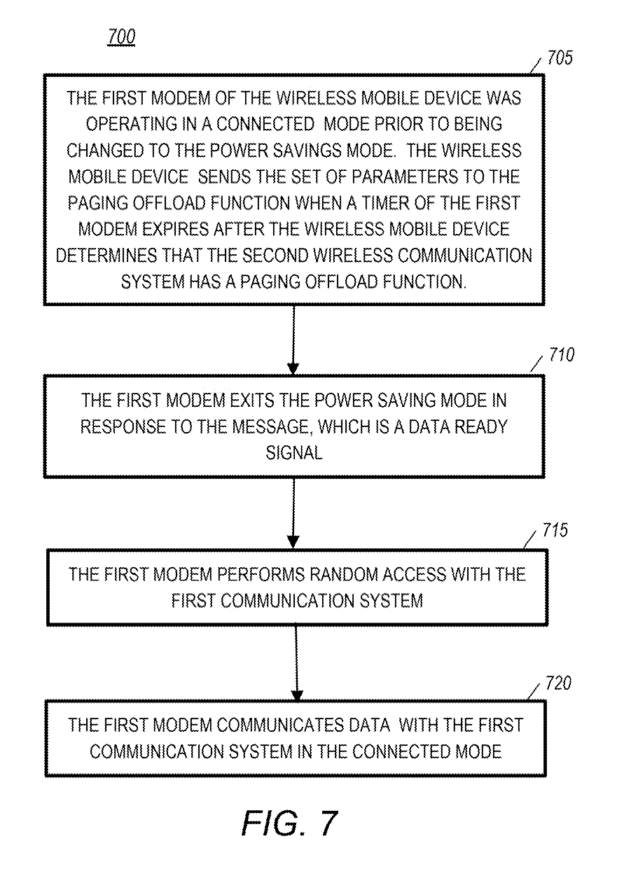

Referring to FIG. 7, a flow chart 700 shows some steps used after step 405 described above with reference to FIG. 4, in accordance with certain embodiments. In these steps 705-720, the first modem of the wireless mobile device was operating in a connected mode of the first wireless communication system prior to being changed to the power saving mode in step 230 of FIG. 2. In one example the first wireless communication system is an LTE cellular system. However these steps are applicable to other wireless communication systems that have equivalent functions. At step 705, the wireless mobile device sends the set of parameters to the paging offload function, using the second modem, when a timer of the first modem expires after the wireless mobile device determines that the second wireless communication system has a paging offload function at step 210 (FIG. 2). The time may be an inactivity timer such as the one described above, which in some cellular systems is a TA timer in an LTE system, In other systems an inactivity timer may be simply a timer of data inactivity. At step 710 the first modem exits the power saving mode in response to the message, which is a data ready signal. At step 715 the first modem performs random access with the first communication system. At step 720 the first modem communicates data with the first communication system in the connected mode.

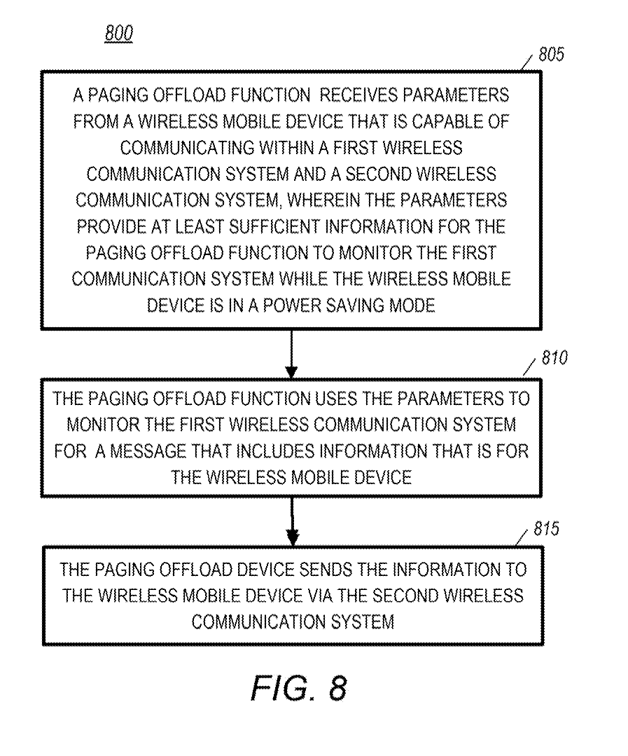

Referring to FIG. 8, a flow chart 800 shows some steps of a method used in a paging offload function that operates with a node in a second wireless communication system. The paging offload function may comprise a device that includes processing functions, a first modem capable of communicating with the first wireless communication system, and a communication function that allows communication within the second wireless communication system, which may be a cabled link such as an Ethernet, USB IEEE 1394b link, or a wireless modem compatible with the second wireless communication system. At step 805, a paging offload function receives parameters from a wireless mobile device that is capable of communicating within a first wireless communication system and within a second wireless communication system, wherein the parameters provide at least sufficient information for the paging offload function to monitor the first communication system while the wireless mobile device is in a power saving mode. At step 810 the paging offload function uses the parameters to monitor the first wireless communication system for a message that includes information that is for the wireless mobile device. At step 815 the paging offload device sends the information to the wireless mobile device via the second wireless communication system. Descriptions of particulars of this method have been described herein above and are not repeated here for the sake of brevity.

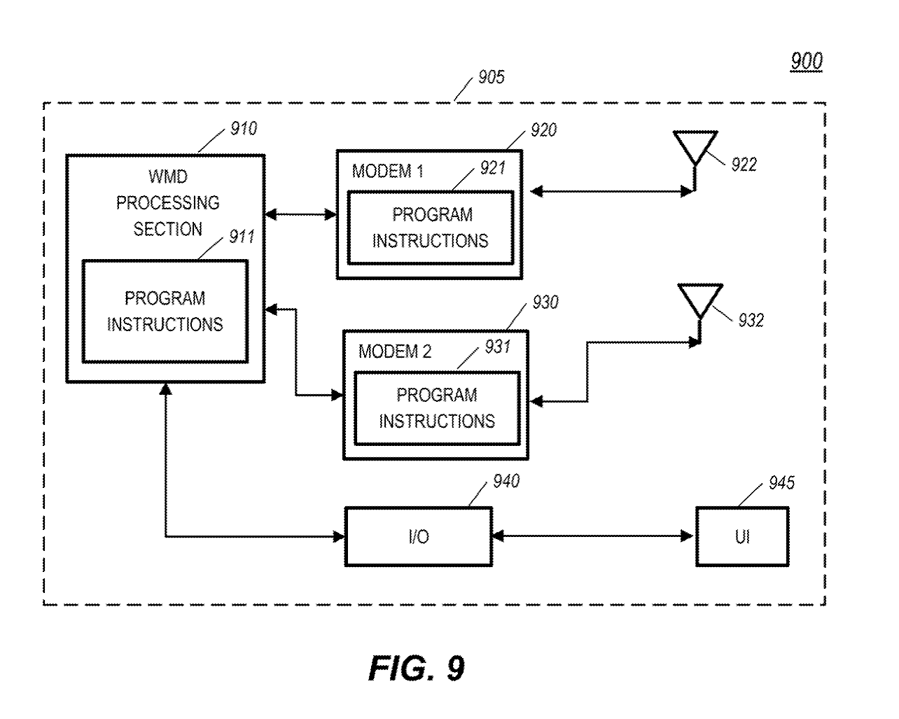

Referring to FIG. 9, a functional block diagram 900 of a wireless mobile device 905 is shown, in accordance with certain embodiments. The WMD 905 comprises a WMD processing section 910, a first modem (MODEM 1) 920, a first antenna 922, a second modem 930, a second antenna 932, an input/output (I/O) function 940, and a user interface function 945. The WMD 905 is capable of performing the functions of the wireless mobile device 110 described above with reference to FIGS. 1-7. The wireless mobile device 905 includes a processing section 910 comprising one or more processing devices, each of which may include such sub-functions as central processing units, cache memory, instruction decoders, just to name a few. The processing section 910 executes program instructions 911 which may be located within memory within the processing devices, or may located in memory (not shown in FIG. 9) external to the processing section 910, or in a combination of both. The program instructions 911 that are executed by the processing section generally include instructions for controlling user interface functions.

The first modem 920 is coupled to the WMD processing section 910 and comprises conventional radio circuit functions that provide wireless communications compatible with the first wireless communication system. The first modem 920 performs conventional wireless modem functions (clock synchronization, link establishment, and converting data and voice signals from the WMD processing section 910 into data that is radio frequency modulated and transmitted according to protocol for the first wireless communication system. The first modem 920 also demodulates radio frequency signals from the first wireless communication system and converts the demodulated signals to voice or data signals that are coupled to the WMD processing section 910. The first modem 920 may have its own processing section (not explicitly shown in FIG. 9) for performing the conventional modem functions described herein, as well as the unique functions described with reference to FIGS. 1-7. Program instructions 921 for the first modem 920 are located in a memory that may be physically associated with a processor or processors that are physically associated specifically with the first modem 920, or the program instructions 921 may be located in other memory in the WMD 905. In some embodiments, the WMD processing section 910 may perform the functions of the processing section for the first modem 920. The first modem 920 is coupled to a first antenna 922, which is optimized for radiating signals in a frequency band of the first wireless communication system.

The second modem 930 has features that are much the same as the features of the first modem 920. A description of the second modem 930 is obtained by modifying the description of the first modem 920 by substituting “second” for “first” and substituting 930, 911 respectively, for 920, 921. The second modem 930 is coupled to a second antenna 932 optimized for radiating signals in the second wireless communication system. The antennas 922, 932 are internal to the wireless mobile device 905 in many embodiments, but may be external to the wireless mobile device 705 in some embodiments. The antennas 922, 932 may each comprise multiple antennas, such as antennas having differing polarizations or positions.

The first modem 920 is some embodiments is a cellular modem, and in some of those embodiments is an LTE cellular modem. The second modem 930 in some embodiments is a Wi-Fi modem. The I/O 940 in some embodiments may be included in the processing section 910. The I/O 940 is coupled to the WSD processing section 910 and provides for communications between the user and user interface hardware elements (UI 945) of the wireless mobile device 905, such as keys, displays, and to wired I/O such as that which uses standard hardware and software protocols (e.g., Universal Serial Bus. In some embodiments, the first and second modems 920, 930 may not comprise entirely independent hardware. The first and second modems 920, 930 are able to function simultaneously and compatibly (i.e., without interfering with each other).

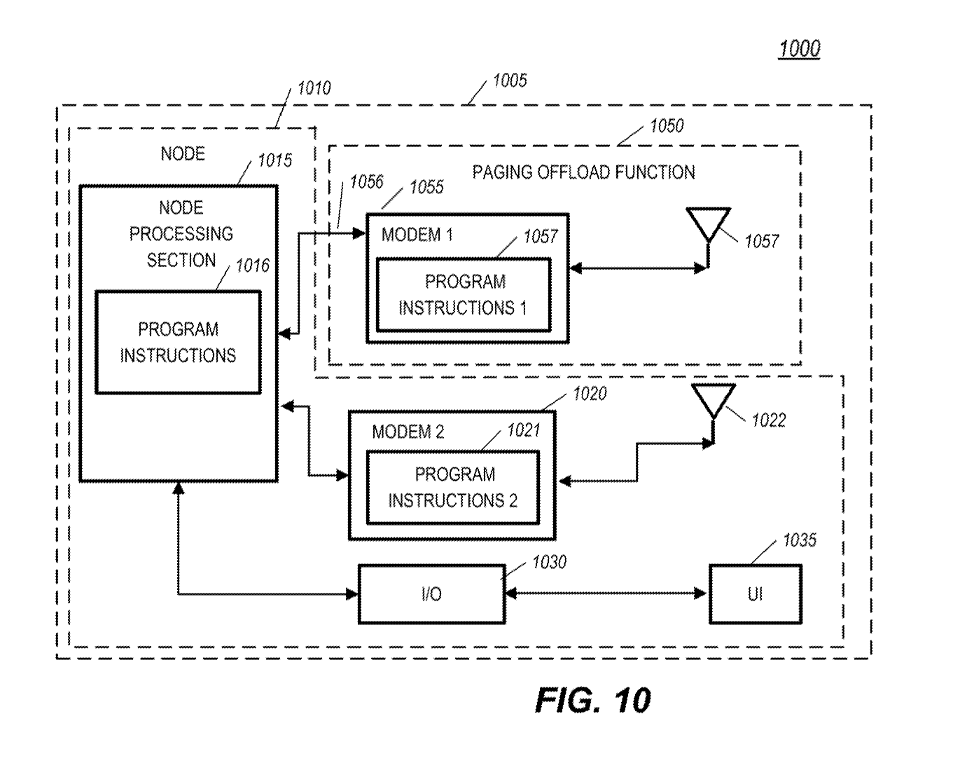

Referring to FIG. 10, a functional block diagram 1000 shows a wireless network device 1005, in accordance with certain embodiments. The WND 1005 is capable of performing the functions of the wireless network device 155 (FIG. 1), described above primarily with reference to FIGS. 1 and 8. Details and clarification of some terms and concepts described with reference to FIGS. 1 and 8 are provided in the descriptions that reference FIGS. 2-7. The WND 1005 comprises a node 1010 coupled by a connection 1056 to a paging offload function 1050. The node 1010 comprises a node processing section 1015, a second modem 1020 coupled to the node 1010 and to a second antenna 1022, an input/output (I/O) function 1030 coupled to the node 1010 and to a user interface function 1035. The paging offload function comprises a first modem 1055 coupled to the node 1010 and to a first antenna 1057. The node 1010 comprises a processing section 1015 comprising one or more processing devices, each of which may include such sub-functions as central processing units, cache memory, instruction decoders, just to name a few. The processing section 1015 executes program instructions 1016 which may be located within memory within the processing devices, or may located in memory (not shown in FIG. 10) external to the processing section 1015, or in a combination of both. The program instructions 1016 that are executed by the processing section 1015 may provide functions that are equivalent to functions of a conventional node of the second wireless communication system.

The second modem 1020 is coupled to the node processing section 1015 and comprises conventional radio circuit functions that provide wireless communications compatible with the second wireless communication system. The second modem 1020 performs conventional wireless modem functions (clock synchronization, link establishment, and converting data and voice signals from the node processing section 1015 into data that is radio frequency modulated and transmitted according to protocol for the second wireless communication system. The second modem 1020 also demodulates radio frequency signals from the second wireless communication system and converts the demodulated signals to voice or data signals that are coupled to the node processing section 1015. The second modem 1020 may have its own processing section (not explicitly shown in FIG. 10) for performing conventional modem functions. Program instructions 1021 for the second modem 1020 are located in a memory that may be physically associated with a processor or processors that are physically associated specifically with the second modem 1015, or the program instructions 1021 may be located in other memory in the node 1010. In some embodiments, the node processing section 1015 may perform the functions of the processing section for the second modem 1020. The second modem 1020 is coupled to a first antenna 1022, which is optimized for radiating signals in a frequency band of the second wireless communication system.

The first modem 1055 has features that are much the same as the features of the second modem 1020, except that the first modem also has certain unique functions. The description of the first modem 1055 is the same as the description of the second modem 1020, by substituting “first” for “second” and substituting 1055, 1057 respectively, for 1020, 1021, except that the program instructions for the first modem 1055 provide unique functions of the paging offload function 160 that are described with reference to FIGS. 1 and 8. The node 1010 may be included in the same device with the POF 1050, or may be separate. When the node 1010 and the POF 1050 are in the same device, the coupling 1056 may be by circuit level techniques such as wires and printed circuit board runners. When the node 1010 and the POF 1050 are in different devices, then the coupling 156 may be either cabled (e.g., Ethernet, USB, or IEEE 1394b) or wireless. When the coupling 1056 is wireless it may be by means of nodes for the second wireless communication system or other wireless communication systems. The first modem 1055 is coupled to a first antenna 1057 optimized for radiating signals in a frequency band of the first wireless communication system. Each of the antennas 1022, 1057 may be internal or external. The first modem 1057 is some embodiments is a cellular modem, and in some of those embodiments is an LTE cellular modem.

The second modem 1020 in some embodiments is a Wi-Fi modem. The I/O 1030 in some embodiments may be included in the node processing section 1015. The I/O 1030 provides for communications between the user and user interface hardware elements (UI 1035) of the node 1010, which typically comprises a few indicators. In some embodiments, the first and second modems 1055, 1020 may not comprise entirely independent hardware. The first and second modems 1055, 1020 are able to function simultaneously and compatibly (i.e., without interfering with each other).

It will be appreciated that the cellular embodiments described herein provide benefits of cellular voice and data communications without undue power consumption in circumstances under which the wireless mobile device and the second wireless communication network could potentially provide some amount of voice or data communications directly through the second wireless communication system. For example, VoIP (voice over internet protocol) could be used to provide voice communications using the second wireless communication system in the circumstances described above. However, achieving this requires compatible applications in the call handling networks and wireless mobile device, and the call does not have the mobility advantage of a cellular call. For example, a VoIP call over the second wireless communication system that is a wireless local area network will be lost when the wireless mobile device is moved out of range of the second wireless communication system, unless complicated handoff techniques are included in applications in the wireless mobile device and the network accepting the call. Also, other advantages of cellular communications can be lost, such as 911 location determination, and quality of service management.

It should be apparent to those of ordinary skill in the art that for the methods described herein other steps may be added or existing steps may be removed, modified or rearranged without departing from the scope of the methods. Also, the methods are described with respect to the apparatuses described herein by way of example and not limitation, and the methods may be used in other systems.

Reference throughout this document are made to “one embodiment”, “certain embodiments”, “an embodiment” or similar terms The appearances of such phrases or in various places throughout this specification are not necessarily all referring to the same embodiment. Furthermore, the particular features, structures, or characteristics attributed to any of the embodiments referred to herein may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The processes illustrated in this document, for example (but not limited to) the method steps described in FIGS. 1-8, may be performed using programmed instructions contained on a computer readable medium which may be read by processor of a CPU. A computer readable medium may be any tangible medium capable of storing instructions to be performed by a microprocessor. The medium may be one of or include one or more of a CD disc, DVD disc, magnetic or optical disc, tape, and semiconductor based removable or non-removable memory. The programming instructions may alternatively be carried in the intangible form of packetized or non-packetized wireline or wireless transmission signals.

It is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method used in a wireless mobile device that is capable of communicating within a first wireless communication system using a first wireless modem and communicating within a second wireless communication system using a second wireless modem, comprising:
associating with the second wireless communication system;
determining that the second wireless communication system includes a paging offload function;
establishing a link to the paging offload function
providing a set of parameters over the link that the paging offload function can use to monitor signals of the first wireless communication system on behalf of the wireless mobile device; and
changing a mode of the first modem of the wireless mobile device into a power saving mode.

2. The method according to claim 1, wherein the second wireless communication system is one of a Wi-Fi and a Bluetooth communication system.

3. The method according to claim 1 wherein the first wireless communication system is an LTE system and the parameters provided to the paging offload function are parameters that define DRX timing being used when the link to the paging offload function is established.

4. The method according to claim 1, wherein changing the wireless mobile device into the power saving mode is performed in response to receiving a message indicating that the set of parameters has been successfully received by the paging offload device.

5. The method according to claim 1, wherein changing the wireless mobile device into the power saving mode comprises decreasing a value of a power-on duty cycle of the first modem from a value of the power-on duty cycle that existed prior to changing the first modem to the power saving mode.

6. The method according to claim 1, further comprising:
receiving a message from the paging offload function that includes information received from first wireless communication system that is intended for the wireless mobile device.

7. The method according to claim 6, further comprising changing the mode of the first modem to an active communication mode in the first wireless communication system in response to the information

8. The method according to claim 6, wherein the first modem was operating in an idle mode prior to being changed to the power saving mode, and further comprising:
performing random access in the first wireless communication system in accordance with the information received in the message.

9. The method according to claim 6, wherein the first modem was operating in a connected mode prior to being changed to the power saving mode, and further comprising:
sending the set of parameters to the paging offload function when a timer of the first modem expires after the wireless mobile device determines that the second wireless communication system has a paging offload function; and
exiting the power saving mode in response to the message.

10. A method used in a paging offload function operating within a second wireless communication system, wherein the paging offload function is capable of monitoring signals of a first wireless communication system comprising:
receiving parameters from a wireless mobile device that is capable of communicating within the first wireless communication system and the second wireless communication system, wherein the parameters provide at least sufficient information for the paging offload function to monitor the first wireless communication system on behalf of the wireless mobile device while the wireless mobile device is in a power saving mode;
using the parameters to monitor the first wireless communication system for a message that includes information that is for the wireless mobile device; and
sending the information to the wireless mobile device via the second wireless communication system.

11. The method according to claim 10, wherein the second wireless communication system is one of a Wi-Fi and a Bluetooth communication system.

12. The method according to claim 10, wherein the first wireless system is an LTE system and the parameters received by the paging offload function are parameters that define DRX timing being used by the wireless mobile device to operate with the first wireless communication system when the link to the paging offload function is established.

13. The method according to claim 12, wherein the cellular system is an LTE system and the DRX parameters are parameters for one of an idle mode and a connected DRX mode.

14. A wireless mobile device, comprising:
a first modem for communicating in a first wireless communication system;
a second modem for communicating in a second wireless communication system; and
program instructions that control one or more processing functions of the wireless mobile device to:
control the second modem to associate with the second wireless communication system, determine that the second wireless communication system includes a paging offload function, and establish a link to the paging offload function,
control the first modem to provide a set of parameters that are sent over the link by the second modem that the paging offload function can use to monitor signals of the first wireless communication system on behalf of the wireless mobile device; and
control the first modem to change device mode of the first modem into a power saving mode.

15. The wireless mobile device according to claim 14, wherein the programming instructions further control the one or more processing functions of the wireless mobile device receive a message by the second modem from the paging offload function that includes information received from the first wireless communication system that is for the wireless mobile device.

16. The wireless mobile device according to claim 15, wherein the programming instructions further control the one or more processing functions of the wireless mobile device to change the first modem into an active communication mode in the first wireless communication system in response to the information.

17. A wireless network device, comprising:
a first modem for communicating in a first wireless communication system;
a second modem for communicating in a second wireless communication system; and
program instructions that control one or more processing functions of the wireless network device to:
receive parameters by the second modem from a wireless mobile device that is capable of communicating within the first wireless communication system and the second wireless communication system, wherein the parameters provide at least sufficient information for the first modem to monitor the first wireless communication system on behalf of the wireless mobile device while the wireless mobile device is in a power saving mode,
use the parameters by the first modem to monitor the first wireless communication system for a message that includes information that is for the wireless mobile device, and
send the information by the second modem to the wireless mobile device via the second wireless communication system.

18. The wireless network device according to claim 17, wherein the second modem is one of a Wi-Fi and a Bluetooth modem.
